(19) United States
(12) Patent Application Publication
(10) Pub. No.: US 2009/0208048 A1
(43) Pub. Date: Aug. 20, 2009

(54) LOUDSPEAKER WITH REDUCED ROCKING TENDENCY

(75) Inventor: Christian Haas, Gross St. Florian (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/301,125

(22) PCT Filed: May 5, 2007
(86) PCT No.: PCT/IB2007/051855

§ 371 Date: Nov. 17, 2008

(30) Foreign Application Priority Data
May 17, 2006 (EP) 06114099.2

(51) Int. Cl. H04R 1/02

(52) U.S. Cl. 381/349

(57) ABSTRACT

A loudspeaker (13, 16) comprises an electro dynamic transducer (1) and a bass reflex enclosure (14, 17), in which the electro dynamic transducer (1) is mounted. The diaphragm (2) of the transducer, when driven, vibrates in a rocking mode with a rocking frequency and the bass reflex enclosure (14, 17) is tuned to the rocking frequency.

### FIELD OF THE INVENTION

The invention relates to a loudspeaker, comprising: an electro dynamic transducer whose diaphragm, when driven, vibrates in a rocking mode with a rocking frequency; and a bass reflex enclosure, in which said electro dynamic transducer is mounted.

The invention furthermore relates to a mobile device, comprising an inventive loudspeaker, in particular to a mobile phone, a PDA, a mobile computer, or a toy.

### BACKGROUND OF THE INVENTION

A loudspeaker in the context of this patent comprises an electro dynamic transducer mounted in an enclosure. The electro dynamic transducer converts an electrical signal into sound. A purpose of the enclosure, which is also called a cabinet, is to prevent combining out-of-phase sound waves generated by the rear of the transducer with the positive phase sound waves generated by the front of the transducer, which would result in interference patterns and cancellation causing the efficiency of the loudspeaker to be compromised.

FIGS. 1 and 2 show an example of an electro dynamic transducer 1. FIG. 1 shows the transducer 1 in a top view and FIG. 2 shows the transducer 1 in a cross-sectional view. The transducer 1 comprises a diaphragm 2, a coil 3 attached to the diaphragm 2, a magnet 4 interacting with the coil 3, and a frame 5. The frame 5 holds the magnet 4 and holds the diaphragm 2 via a surround 6. If an electric signal is applied to the coil 3, then the coil 3 causes the diaphragm 2 to vibrate in piston motion as indicated by a velocity vector 7. Ideally, all points of the diaphragm 2 move uniformly relative to the velocity vector 7 as illustrated in FIG. 3. In some circumstances, however, the diaphragm 2 may move as indicated by arrows 8, resulting in vibratory rotational motion about an axis 9. The non-piston motion of this type is illustrated in FIG. 4 and is also referred to as “rocking mode”, which may particularly present itself if the transducer does not comprise a spider as it is the case for the transducer 1 shown.

Rocking mode vibration is undesirable, because it may result in loss of acoustic efficiency or may distort the acoustic signal generated by the transducer 1.

Published European application for patent 1 555 849 A2 discloses an acoustic passive radiator with rocking mode reduction. The passive radiator, which is sometimes referred to as a “drone”, comprises a diaphragm for radiating acoustic energy and a suspension. The diaphragm has a perimeter portion and a central portion which is thinner than the perimeter portion. The suspension includes a skin element encasing the diaphragm. The skin element comprises a surround for physically coupling the passive radiator to an enclosure, pneumatically sealing the diaphragm and the enclosure. A non-surround, non-spider suspension element coacts with the surround to control the motion and to support the weight of the diaphragm.

### OBJECT AND SUMMARY OF THE INVENTION

It is an object of the invention to provide a loudspeaker whose enclosure at least supports reducing the rocking mode of the transducer of the loudspeaker.

The object of the invention is achieved by means of a loudspeaker, comprising an electro dynamic transducer whose diaphragm, when driven, can vibrate in a rocking mode with a rocking frequency, and a bass reflex enclosure, in which the electro dynamic transducer is mounted. The bass reflex enclosure is tuned to the rocking frequency. A bass reflex enclosure, also referred to as ported or vented enclosure, is a type of loudspeaker enclosure utilizing the sound from the rear side of the diaphragm of the transducer. Contrary to closed box loudspeakers, which are substantially airtight, the bass reflex enclosure comprises an opening, usually called a port or a vent, which may comprise a pipe or a duct, normally of rectangular or circular cross section. The opening resonates with the air inside the enclosure. The frequency, at which the bass reflex enclosure resonates is sometimes referred to as the Helmoltz resonance and depends on the size of enclosure and on the dimensions of the port. For conventional loudspeakers, a bass reflex enclosure is used to extend the frequency response of the loudspeaker below the range the transducer could reproduce in a closed enclosure. Thus, conventional bass reflex enclosures are tuned to a certain bass frequency.

The bass reflex enclosure of the inventive loudspeaker, however, is tuned to the rocking frequency of the electro dynamic transducer. Due to this inventive tuning, the excursion of the diaphragm of the transducer at the rocking frequency is at least decreased, if not completely suppressed. Therefore, if the bass reflex enclosure is tuned to the rocking frequency of the transducer, then the transducer is less prone to be excited at this frequency, resulting in less rocking of the diaphragm.

Electro dynamic transducers may comprise a spider system for improved stability of the diaphragm. Such spider systems may reduce the rocking of the transducer. Particularly for low-cost applications, transducers without such a spider system are used, such as the transducer 1 described in the introduction. The inventive tuning of the bass reflex enclosure is especially useful if a transducer without a spider is used.

Since the enclosure of the inventive loudspeaker is a bass reflex enclosure, it comprises an opening, commonly known as a port or a vent. The port has a cross-section S_{R} of any shape and a length L_{R}. Particularly, the cross section S_{R} may be circular or rectangular and the enclosure has a volume V_{B}. Then, the length L_{R} of the port may be determined in order to tune the bass reflex enclosure to the rocking frequency f_{rock} of the transducer, according to the following equation:

$${L}_{R} = \frac{{S}_{R} \cdot {c}^{2}}{4 \cdot {V}_{B} \cdot {π}^{2} \cdot {f}_{rock}^{2}}$$

wherein c is the sound velocity in air.

The inventive loudspeaker may particularly be used for a mobile device, for instance, a mobile phone, a PDA, a mobile computer, or a toy.

The object is also achieved in accordance with the invention by means of a loudspeaker, comprising an electro dynamic transducer whose diaphragm, when driven, vibrates with a resonance frequency in free air, and a bass reflex enclosure, in which the electro dynamic transducer is mounted. The bass reflex enclosure is tuned to a frequency which equals 1.5 times the resonance frequency fᵣₑₛ in free air. Electro dynamic transducers without a spider centering system, such as the transducer 1 described in the introduction, have often a rocking frequency of approximately 1.5 times the free air resonance frequency fᵣₑₛ of the transducer. This is particularly true for transducers whose diaphragms are made of a material with a relative low inner damping. Such transducers are especially used for low-cost applications or for mobile devices, such as mobile phones, mobile computers, PDAs, or toys. Consequently, if the bass reflex enclosure is tuned to 1.5 times the resonance frequency fᵣₑₛ in free air, then the corresponding bass reflex loudspeaker is likely to be tuned to the rocking frequency of the used electro dynamic transducer.

The parameters of the port of such an inventive enclosure may then be determined according to the following equation:

$${L}_{R} = \frac{{S}_{R} \cdot {c}^{2}}{9 \cdot {V}_{B} \cdot {π}^{2} \cdot {f}_{res}^{2}}$$

### BRIEF DESCRIPTION OF THE DRAWINGS

The invention will be described in greater detail hereinafter by way of non-limiting examples with reference to the embodiments shown in the drawings.

FIGS. 1 to 4, as discussed above, illustrate the rocking mode of an electro dynamic transducer;

FIG. 5 is a plot illustrating the diaphragm excursion versus frequency of an electro dynamic transducer;

FIGS. 6 and 7 are loudspeakers comprising an electro dynamic transducer and bass reflex enclosures;

FIG. 8 are plots illustrating the sound pressure levels versus frequency of the transducer and at the port of the bass reflex enclosure of FIG. 7.

FIG. 9 is a mobile phone comprising the loudspeaker of FIG. 7.

### DESCRIPTION OF EMBODIMENTS

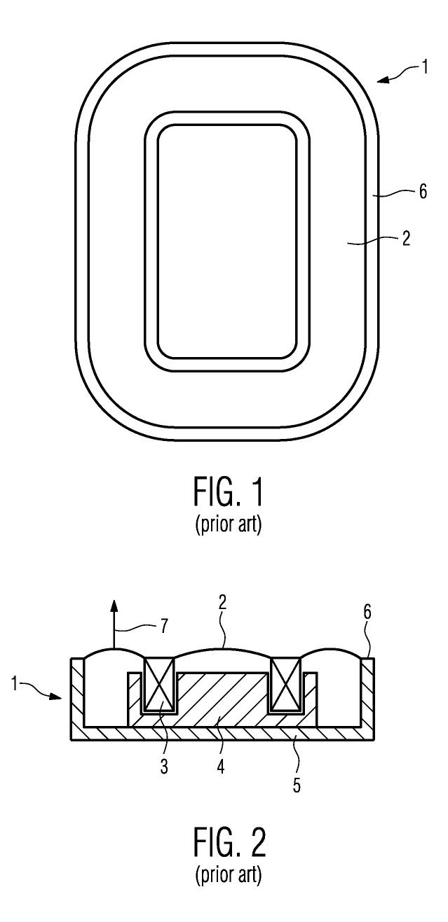

FIGS. 1 to 4 have been discussed in the introduction.

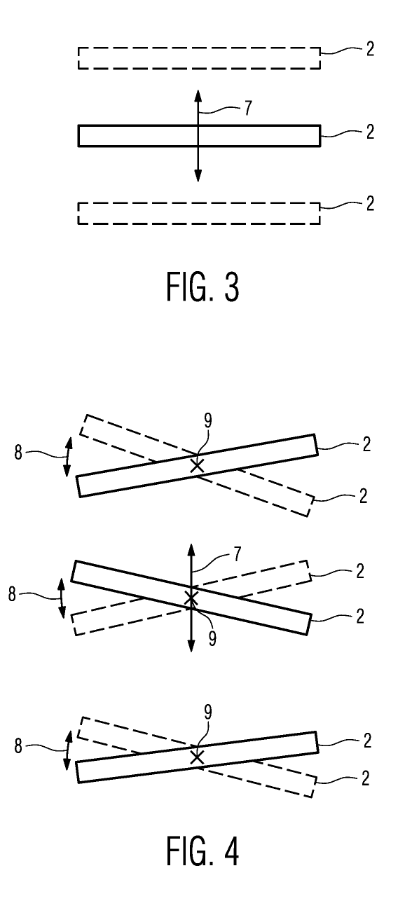

FIG. 5 is a plot 10 illustrating the diaphragm excursion versus frequency of a typical electro dynamic transducer without a spider centering system and in free air, i. e. if the transducer is not attached to an enclosure. For the exemplary embodiment, this transducer is the transducer 1 of FIGS. 1 to 4. The plot 10 shows a first peak 11 at 750 Hz and a second peak 12 at about 1 kHz. The first peak 11 corresponds to the resonance frequency fᵣₑₛ in free air of the transducer 1 at about 750 Hz and the second peak 12 corresponds to the rocking frequency f_{rock} of the transducer 1. The rocking frequency f_{rock} is approximately 1000 kHz for the exemplary embodiment. Thus, the rocking frequency f_{rock} of this transducer 1 is approximately 1.5 times the resonance frequency in free air of the transducer 1. This is relatively often the case for electro dynamic transducers with diaphragms having a relatively low inner damping. Such transducers are used, for instance, for mobile devices, such as mobile telephones, PDAs, Laptops, or toys.

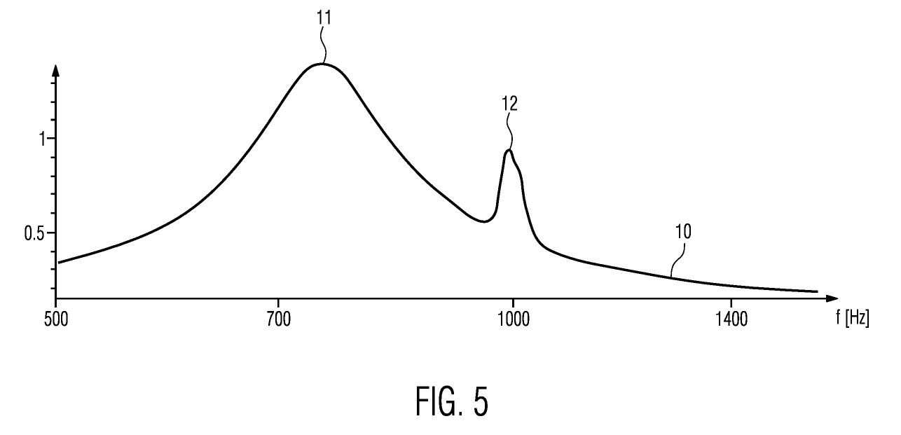

FIG. 6 shows a first exemplary embodiment of an inventive loudspeaker 13 which comprises an enclosure 14 and the transducer 1 of FIGS. 1 to 4 for the exemplary embodiment. The enclosure 14 has a volume V_{B,1} and is a bass reflex enclosure with an opening 15. The opening 15 has a cross-section S_{R,1} and a length which corresponds to the thickness d of the walls of the enclosure 14.

The transducer 1 has a rocking frequency f_{rock} of approximately 1 kHz as illustrated by FIG. 5. The enclosure 14 of the loudspeaker 13 is tuned to this rocking frequency f_{rock}, i.e. the volume V_{B,1}, the cross-section S_{R,1}, and the thickness of the walls of the enclosure 14 are chosen so that the system comprised of the transducer 1 and the enclosure 14 resonates at the rocking frequency f_{rock}. For the exemplary embodiment, the cross-section S_{R,1} of the opening 15 is rectangular and is chosen to satisfy the following equation:

$$\begin{matrix}{S}_{R , 1} = 4 \cdot \frac{d \cdot {V}_{B , 1} \cdot {π}^{2} \cdot {f}_{rock}^{2}}{{c}^{2}} \\ = 4 \cdot {( 1000 Hz )}^{2} \cdot \frac{d \cdot {V}_{B , 1} \cdot {π}^{2}}{{c}^{2}}\end{matrix}$$

wherein c is the sound velocity in air.

Alternatively, the enclosure 14 is tuned to a frequency, which equals 1.5 times the resonance frequency fᵣₑₛ in free air of the transducer 1. Then, the cross-section S_{R,1} of the opening 15 is chosen to satisfy the following equation for the exemplary embodiment:

$$\begin{matrix}{S}_{R , 1} = 9 \cdot \frac{d \cdot {V}_{B , 1} \cdot {π}^{2} \cdot {f}_{res}^{2}}{{c}^{2}} \\ = 9 \cdot {( 750 Hz )}^{2} \cdot \frac{d \cdot {V}_{B , 1} \cdot {π}^{2}}{{c}^{2}}\end{matrix}$$

FIG. 7 shows a second exemplary embodiment of an inventive loudspeaker 16, which comprises the transducer 1 and a bass reflex enclosure 17. The enclosure 17 has a volume V_{B,2} and comprises a reflex port 18. The port 18 has a length L and a cross-section S_{R,2}. The cross-section S_{R,2} is circular for the exemplary embodiment.

The length L of the port 18 is dimensioned so that the system comprised of the transducer 1 and the enclosure 16 resonates at the rocking frequency f_{rock}. For the exemplary embodiment, the length L of the port 18 is dimensioned so that the following equation is satisfied:

$$L = \frac{{S}_{R , 2} \cdot {c}^{2}}{4 \cdot {V}_{b , 2} \cdot {π}^{2} \cdot {f}_{rock}^{2}}$$

Alternatively, the enclosure 17 is tuned to a frequency, which equals 1.5 times the resonance frequency fᵣₑₛ in free air of the transducer 1. Then, the length L of the port 18 is chosen to satisfy the following equation for the exemplary embodiment:

$$L = \frac{{S}_{R , 2} \cdot {c}^{2}}{9 \cdot {V}_{B , 2} \cdot {π}^{2} \cdot {f}_{res}^{2}}$$

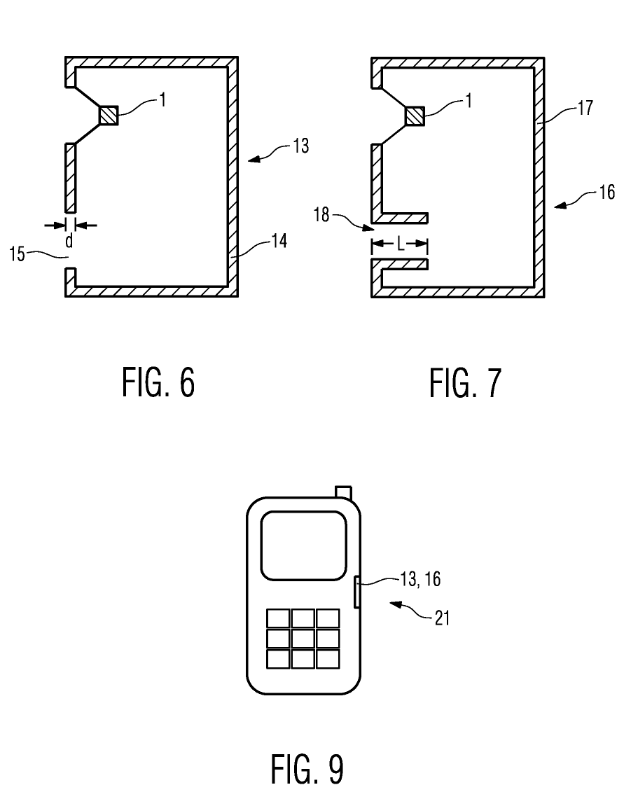

FIG. 8 shows a plot 19 illustrating the sound pressure levels Lₚᵢ versus the normalized frequency ωₙ of the diaphragm 2 of the transducer 1 and a plot 20 illustrating the sound pressure levels versus the normalized frequency ωₙ at the port 18. The frequency axis is normalized so that the frequency ωₙ=1 corresponds to the rocking frequency f_{rock} of the transducer 1. From plot 19 is obvious that the diaphragm 2 of the transducer 1 produces no or at least hardly any sound. This means that the diaphragm 2 does not move at all or at least moves very little at the rocking frequency f_{rock}.

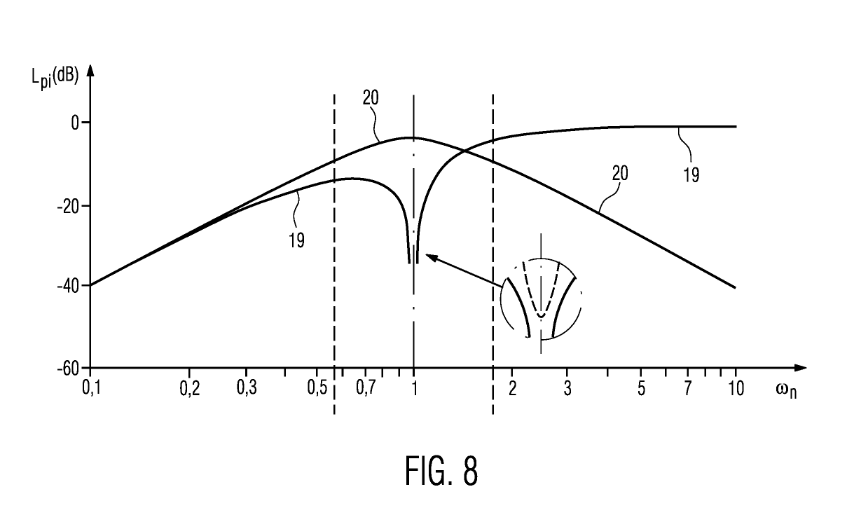

The loudspeakers 13, 16 are particularly used for a mobile device, such as a mobile phone, a PDA, a mobile computer, or a toy. FIG. 9 shows a mobile phone 21 comprising the loudspeaker 13 or the loudspeaker 16 as an exemplary embodiment of a mobile device.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A loudspeaker, comprising:
an electro dynamic transducer whose diaphragm, when driven, vibrates in a rocking mode with a rocking frequency f_{rock}; and
a bass reflex enclosures, in which said electro dynamic transducer is mounted; said bass reflex enclosure being tuned to said rocking frequency f_{rock}.

2. The loudspeaker of claim 1, wherein said electro dynamic transducer is a spider-less transducer.

3. The loudspeaker of claim 1, wherein said bass reflex enclosure comprises a port with a cross-section and a length that is determined according to:
$${L}_{R} = \frac{{S}_{R} \cdot {c}^{2}}{4 \cdot {V}_{B} \cdot {π}^{2} \cdot {f}_{rock}^{2}}$$
wherein c is the sound velocity in air, f_{rock} is said rocking frequency, S_{R} is said cross-section of said port and V_{B} is the volume of said enclosure.

4. A loudspeaker, comprising:
an electro dynamic transducer whose diaphragm, when driven, vibrates with a resonance frequency fᵣₑₛ in free air; and
a bass reflex enclosure, in which said electro dynamic transducer is mounted; said bass reflex enclosure being tuned to a frequency that equals 1.5 times said resonance frequency fᵣₑₛ in free air.

5. The transducer of claim 4, wherein said electro dynamic transducer is a spider-less transducer.

6. The loudspeaker of claim 4, wherein said bass reflex enclosure comprises a port with a cross-section and a length which is determined according to:
$${L}_{R} = \frac{{S}_{R} \cdot {c}^{2}}{9 \cdot {V}_{B} \cdot {π}^{2} \cdot {f}_{res}^{2}}$$
wherein c is the sound velocity in air, fᵣₑₛ is said resonance frequency in free air, S_{R} is said cross-section of said port and V_{B} is the volume of said enclosure.

7. A mobile device, comprising a loudspeaker according to claim 1.

8. The mobile device of claim 7, being one of a mobile phone, a PDA, a mobile computer, or a toy.
